(19) United States
(12) Patent Application Publication
(10) Pub. No.: US 2022/0277665 A1
(43) Pub. Date: Sep. 1, 2022

(54) MANIPULATIVE FOR MODELING OPERATIONS WITH FRACTIONS

(71) Applicant: Dwight Morton, Frankfort, IL (US)

(72) Inventor: Dwight Morton, Frankfort, IL (US)

(21) Appl. No.: 17/684,181

(22) Filed: Mar. 1, 2022

Related U.S. Application Data
(60) Provisional application No. 63/154,980, filed on Mar. 1, 2021.

(51) Int. Cl. G09B 19/02

(52) U.S. Cl. CPC G09B 19/025

(57) ABSTRACT

A manipulative and related methods for modeling addition, subtraction, multiplication, or division of fractions, mixed numbers, or decimal numbers comprising a board with a series of pits, holes, and counters.

### RELATED APPLICATIONS

The present patent application claims the priority benefit of U.S. Provisional Patent Application Ser. No. 63/154,980, filed Mar. 1, 2021, the content of which is hereby incorporated by reference in its entirety into this disclosure.

### BACKGROUND

Manipulatives are commonly used tools for teaching math. Manipulatives provide concrete ways for students to bring meaning to abstract mathematical ideas. Currently, teachers use manipulatives such as Cuisenaire Rods, Fractions Tiles, Fraction Strips, Drawn 2-dimensional shapes (squares, triangles, etc.), and Play-Doh.

The existing manipulatives for teaching addition/subtraction of fractions have algorithms that are not easily accessible for students deficient in their multiplication facts. The present disclosure provides a manipulative accessible to children as young as seven years of age, regardless of their multiplication fact knowledge. The disclosed manipulative is designed to build an intuitive understanding of abstract algorithms that students will typically learn in school.

### BRIEF SUMMARY

One aspect of the presently disclosed technology includes a manipulative comprising a board, wherein the board comprises a series of pits arranged in rows and at least one counter at the end of the board. In one aspect, the pits are evenly divided and arranged in rows. In another aspect, the board comprises at least twenty pits. In a further aspect, each row comprises at least ten pits.

In one aspect, the board is between 12-36 inches long, alternatively between 19.5-25 inches long, alternatively 23.5 inches long. In another aspect, the board height is between 0.5-1.5 inches, alternatively 0.75-1 inches, alternatively 0.75 inches. In yet another aspect, the board has a width of 4-10 inches, alternatively 5-7 inches, alternatively 5.25 inches. In one aspect, the board further comprises a marking system.

In one aspect, the manipulative further comprises small stones.

In one aspect, the manipulative is used in a method for modeling the addition and subtraction of fractions or modeling the addition and subtraction of mixed numbers.

One aspect of the presently disclosed technology includes a manipulative comprising a board, wherein the board comprises a series of pits arranged in rows and at least one counter or well at the end of the board. In another aspect, the pits are evenly divided and arranged in rows. In another aspect, the board comprises at least eighteen pits. In a further aspect, each row comprises at least nine pits.

In an aspect, the board is between about 12 inches-about 36 inches long. In another aspect, the board height is between about 0.5 inches-about 1.5 inches. In another aspect, the board has a width of about 4 inches-about 10 inches.

In an aspect, the board further comprises a marking system. In another aspect, the marking system is numerical, and the numbers correspond to specific place name values. In another aspect, the marking system comprises a pin system, wherein the board comprises at least one hole for receiving at least one pin. In a further aspect, the placement of the at least one pin corresponds to a specific place name value.

In another aspect, the manipulative further comprises small stones. In another aspect, the manipulative is used in a method for modeling addition, subtraction, multiplication, or division of fractions, mixed numbers, or decimal numbers.

One aspect of the presently disclosed technology includes a method of using a manipulative, the method comprising providing a board, wherein the board comprises a series of pits arranged equally into a top row and a bottom row, at least one counter or well at an end of the board, and at least one hole for receiving at least one pin; providing at least one pin; placing at least one stone in a pit based on a given number; generating an output based on location of the stone; and correlating values based on placement of the at least one pin in at least one hole with a location of at least one stone to generate resulting values.

In another aspect, the method further comprises placing stones in the pits until the number of stones in the top row of the board is equal to the number of stones in the bottom row of the board. In another aspect, the given number is a numerator, a decimal number, a fraction, or a mixed number. In another aspect, the board further comprises a computing system, the computing system comprising an interface to receive the generated output; and a processor configured to execute instructions stored in a memory, wherein execution of the instructions causes the processer to correlate values and generate the resulting values. In another aspect, the board further comprises a display device. In another aspect, the execution of the instructions causes the processor to present the resulting values on the display device.

One aspect of the presently disclosed technology includes a non-transitory computer-readable storage medium comprising instructions that, in response to being executed, cause a computing system to generate an output based on the location of stones on a board of a manipulative; and correlate values based on placement of at least one pin in at least one hole with a location of at least one stone to generate resulting values.

### BRIEF DESCRIPTION OF THE FIGURES

Aspects of the present disclosure will now be described, by way of example only, with reference to the attached Figures, wherein:

FIG. 1 is a top plan view of the manipulative opened in accordance with one aspect of the present disclosure.

FIG. 2 is a side elevation view of the manipulative opened in accordance with one aspect of the present disclosure.

FIG. 3 is a top plan view of the manipulative opened in accordance with one aspect of the present disclosure.

FIG. 4 is a top plan view of the manipulative opened in accordance with one aspect of the present disclosure.

FIG. 5 is a top plan view of the manipulative opened in accordance with one aspect of the present disclosure.

FIG. 6 is a top plan view of the manipulative closed in accordance with one aspect of the present disclosure.

FIG. 7 is a top plan view of the manipulative in accordance with one aspect of the present disclosure.

FIG. 8 is a top plan view of the manipulative in accordance with one aspect of the present disclosure.

FIG. 9A is a top plan view of the manipulative in accordance with one aspect of the present disclosure. FIG. 9B is a side elevation view of the manipulative shown in FIG. 9A.

FIG. 10A is a top plan view of the manipulative in accordance with one aspect of the present disclosure. FIG. 10B is a perspective view of the manipulative in as shown in FIG. 10A.

FIG. 10C is a side elevation view of the manipulative shown in FIG. 10A.

### DETAILED DESCRIPTION

Various aspects will be described in detail with reference to the drawings, wherein like reference numerals represent like parts and assemblies throughout the several views. It is to be understood that this disclosure is not limited to the particular methodology and protocols described herein and, as such, may vary. It is also to be understood that the terminology used herein is for the purpose of describing particular embodiments only and is not intended to limit the scope of the present disclosure or the appended claims.

Unless otherwise defined, all technical and scientific terms used herein have the same meaning as commonly understood by one of ordinary skill in the art to which the methods described herein belong.

The singular form “a”, “an” and “the” include plural referents unless the context clearly dictates otherwise. These articles refer to one or to more than one (i.e., to at least one). The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The term “about” as used in connection with a numerical value throughout the specification and the claims denotes an interval of accuracy, familiar and acceptable to a person skilled in the art. In general, such interval of accuracy is +/−10%.

Where ranges are given, endpoints are included. Furthermore, unless otherwise indicated or otherwise evident from the context and understanding of one of ordinary skill in the art, values that are expressed as ranges can assume any specific value or subrange within the stated ranges in different embodiments of the disclosure, to the tenth of the unit of the lower limit of the range, unless the context clearly dictates otherwise.

The term “exemplary” means serving as a non-limiting example, instance, or illustration. As utilized herein, the terms “e.g.,” and “for example” set off lists of one or more non-limiting aspects, examples, instances, or illustrations.

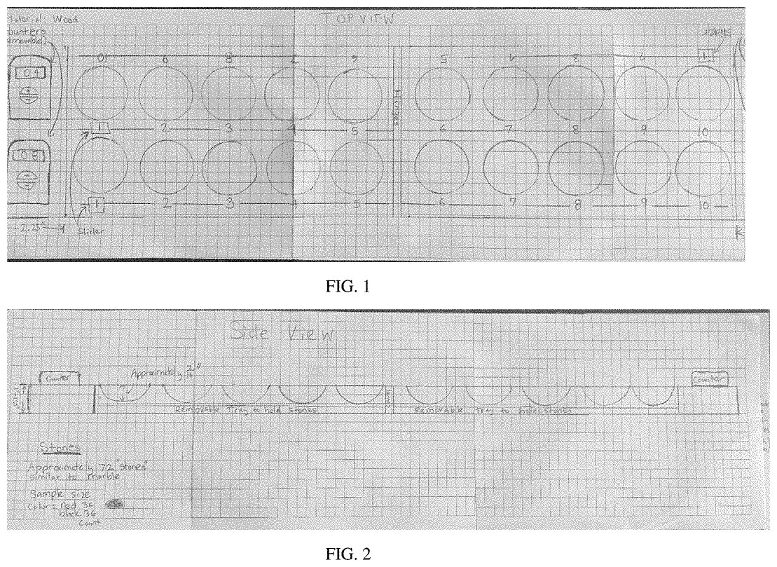

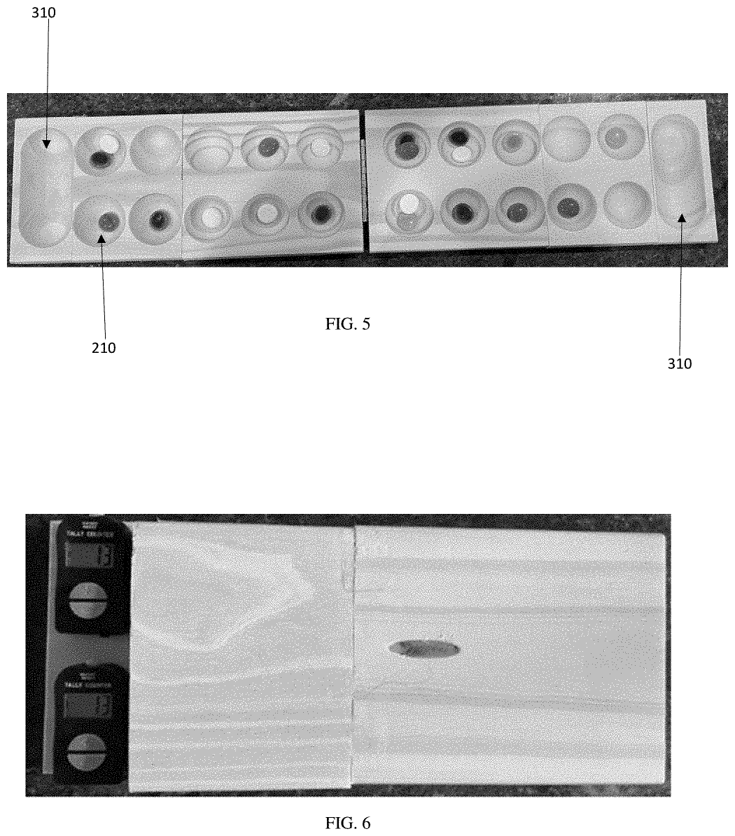

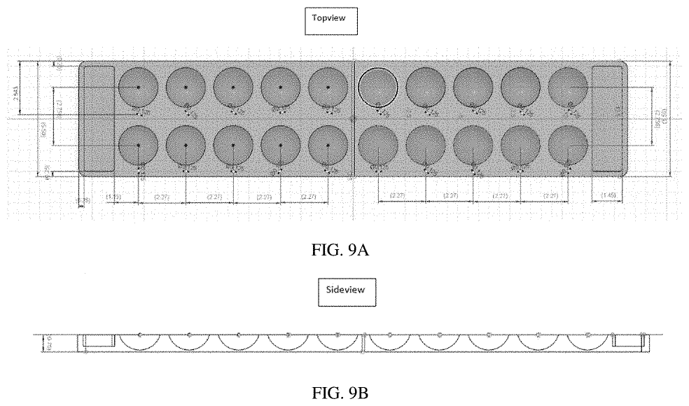

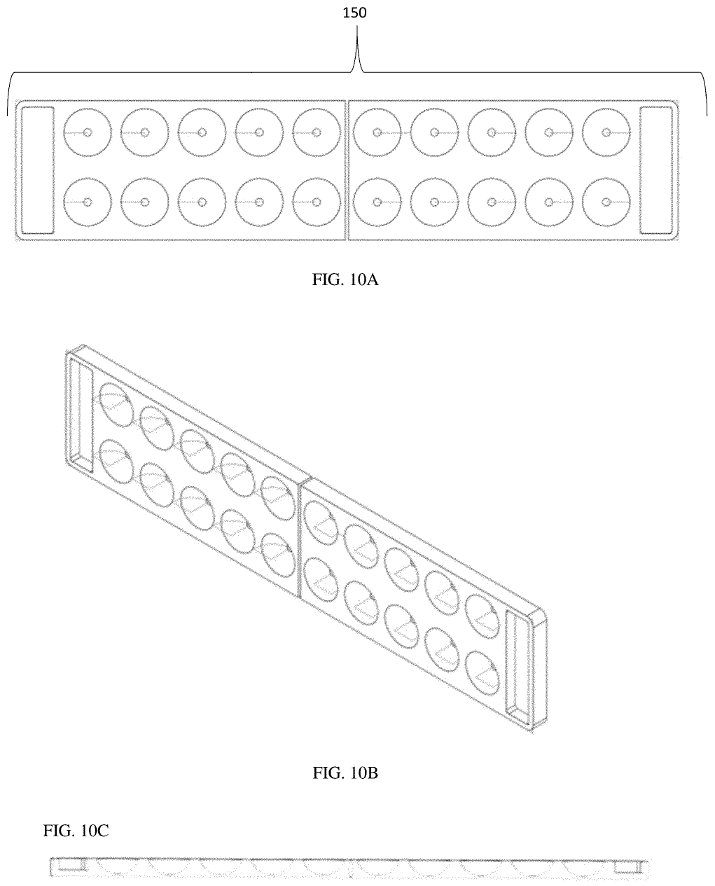

According to at least one aspect of the presently described and claimed technology, a manipulative is described below with reference to FIGS. 1-10.

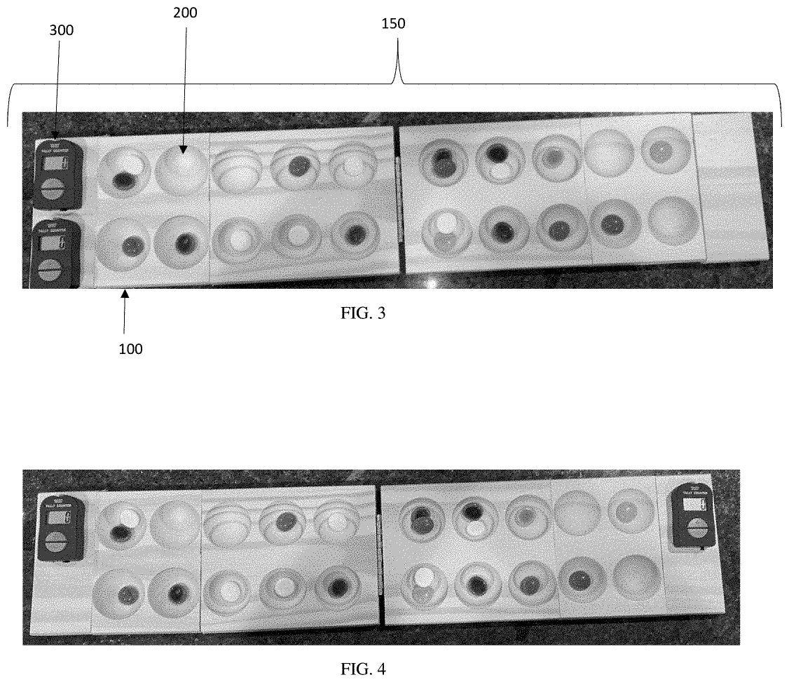

FIGS. 1-10 depict a manipulative 150 comprising a board 100. The board 100 may be constructed from various materials, including, but not limited to, wood, metal, plastic, glass, clay, or ceramics. In the aspects depicted in FIGS. 3-8, the board 100 is constructed from wood. The board 100 comprises a series of pits 200, arranged in rows. The board configurations may vary based on the skill the manipulative is being used to teach. In an aspect, the board 100 comprises twenty pits 200, with ten pits 200 arranged in each row. In another aspect, the board 100 comprises eighteen pits 200, with nine pits 200 arranged in each row. In some aspects, the board further comprises at least one counter 300 at the end of the board 100. In some aspects, the counters 300 are at the same end. In another aspect, the counters 300 are on opposite sides of the board. In some aspects, the board 100 further comprises at least one well 310 at an end of the board 100. In another aspect, the board 100 comprises at least two wells 310 at opposite ends of the board 100. The board 100 may further comprise a marking system 400 that allows a user to count the number of pits 200.

Small counters, or stones 210, are provided for a user to engage with and use the manipulative. In some aspects, the stones 210 are pebbles, marbles, stones, or other small undifferentiated counters placed into the pits 200 and transferred about the pits 200 during use. In an aspect, the stones 210 are marbles. In an aspect, users control the respective sides of their board 100. In another aspect, users may move the stones 210 on the opposite side of the board 100. In an aspect, users control both.

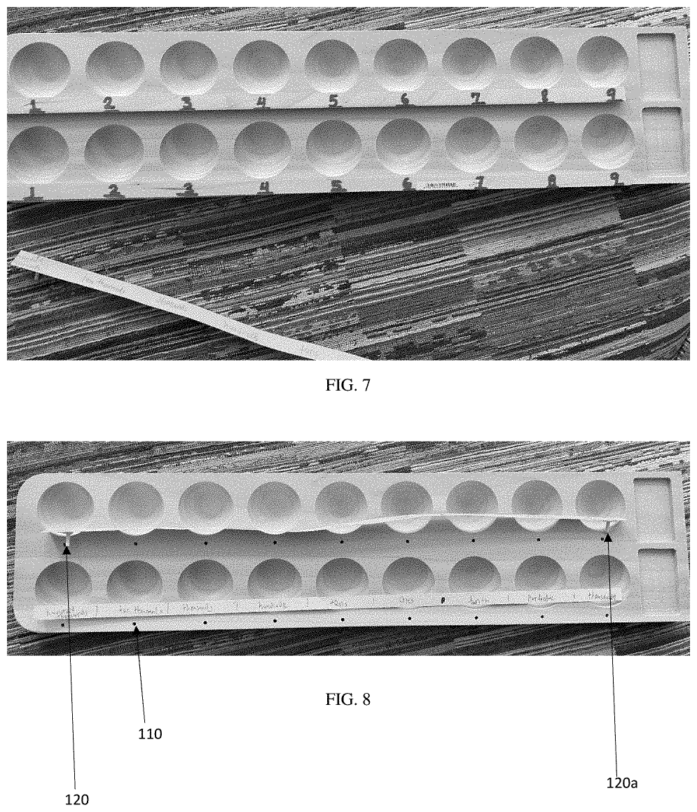

In some aspects, as shown in FIGS. 7 and 8, the marking system corresponds to place name values. The place name values include, but are not limited to, hundred thousands, ten thousands, thousands, hundreds, tens, ones, tenths, hundredths, thousandths, ten thousandths, and hundred thousandths. As shown in FIG. 7, the marking system is numerical, and the numbers correspond to specific place name values. As shown in FIG. 8, the marking system comprises a pin system, wherein the board 100 comprises a hole 110 for receiving a pin 120. The hole 110 and the pin 120 may be of varying depths and/or diameters. As shown in FIG. 8, the hole 110 has a diameter of ⅛ inch and the pin 120 has a ⅛ inch length. In some aspects, the pin 120 is made of wood. However, the pin 120 may be made from various materials, including, but not limited to, wood, metal, plastic, glass, clay, or ceramics. As shown in FIG. 8, the pin 120 may be used to hold a place name value identification whereby the place name identification is placed onto or between two pins 120, 120a that are placed into a hole 110. Alternatively, the pin 120 may be used as a reference or place holder and the placement of the pin 120 corresponds to a specific place name value.

In some aspects, the manipulative 150 is used in a method to model the addition, subtraction, multiplication, and/or division of fractions. In an exemplary method, the method includes a board 100, wherein the board 100 comprises a series of pits 200 arranged equally into a top row and a bottom row, at least one counter 300 or well at the end of the board 100, and at least one hole 110 for receiving at least one pin 120 and at least one pin 120. Stones 210 are placed in the pit(s) 200 based on a given number. An output is then generated based on the location of the stones and correlating values are obtained based on the placement of the at least one pin 120 in at least one hole with a location of the stones 210. The correlating values can be used to generate resulting values based on the type of modeling desired. For example, the location of the starting stones may be dependent on whether the given number is a numerator or a decimal number. The method also further comprises placing stones 210 in the pits 200 until the number of stones 210 in the top row of the board 100 is equal to the number of stones 210 in the bottom row of the board 100. This placement (“Heavenly Number”), corresponds to the smallest positive integer that is divisible by the integers being manipulated (e.g., least common multiple).

In some aspects, the board 100 further comprises a computing system including an interface to receive the generated output; and a processor configured to execute instructions stored in a memory, wherein execution of the instructions causes the processer to correlate values and generate the resulting values. The board 100 may also include a display device (not shown). In an exemplary method, execution of instructions causes the processor to present the resulting values on the display device. In some aspects, the pits 200 include sensors (not shown) and the number of stones 210 in the pits 200 may also be displayed on the display device. In some aspects, the holes 110 include sensors (not shown) and the place name value may also be displayed on the display device based on the location of the pin 120.

Some aspects include a non-transitory computer-readable storage medium comprising instructions that, in response to being executed, cause a computing system to generate an output based on the location of stones 210 on a board 100 of a manipulative 150; and correlate values based on the placement of at least one pin 120 in at least one hole 100 with a location of the stones 210 to generate resulting values.

The term “computer-readable medium” as used herein refers to any media that participates in providing instructions to the one or more processor for execution. Such a medium may take many forms including transitory media (e.g., transmission media) and non-transitory media (e.g., non-volatile media and volatile media). Transmission media may include, for example, coaxial cables, copper wire, fiber optics, the wires that comprise bus, and wireless transmissions. Non-volatile media may include, for example, non-volatile storage devices such as those of the non-volatile memory and/or the storage device. Similarly, the volatile media may include, for example, volatile storage devices such as those of the volatile memory.

Common forms of non-transitory computer-readable media or computer program products include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer may read.

Various forms of non-transitory computer-readable media may be involved in carrying one or more sequences of one or more instructions to the one or more processors for execution. For example, the instructions may initially be carried on the magnetic disk of a remote computer. The remote computer may load the instructions into its dynamic memory and send the instructions over a communications link. A modem or other network interface local to the computing device may receive the instructions transfer the received instructions to volatile memory and/or the one or more processors via bus. The instructions received by volatile memory may optionally be stored to storage device either before or after execution by the one or more processors.

In some aspects, the board 100 is between about 12 inches-about 36 inches long, alternatively between about 19.5 inches-about 25 inches long. In an aspect, the board 100 is about 23.5 inches long. In another aspect, the board height is between about 0.5 inches-about 1.5 inches, alternatively about 0.75 inches-about 1 inch. In an aspect, the board height is about 0.75 inches. In another aspect, the board 100 has a width of about 4 inches-about 10 inches, alternatively about 5 inches-about 7 inches. In an aspect, the board 100 has a width of about 5.25 inches. FIG. 6 depicts an aspect of the manipulative closed. This ability to fold and close the manipulative 150 allows users to carry the manipulative easily. In some aspects, the board 100 comprises handles (not shown). These handles enable a user to carry the manipulative 150.

In some aspect, the manipulative is used for modeling. In some aspects, the manipulative is used to teach a user how to model the addition and subtraction of fractions or how to model the addition and subtraction of mixed numbers.

### EXAMPLES

### Example 1: Adding or Subtracting Fractions

A user was given 2 fractions to manipulate, ⅔ and ⅙. The user set 3 and 6 stones in each row of pits (top & bottom row), respectively. The user then placed a first pin (⅛ inch wooden stick) in a numbered hole (e.g. 1st, 2nd, 3rd, etc.) according to the numerator. The user added stones one at a time to each to each row in order to find the Heavenly Number. The Heavenly Number is the number when the number of stones in the top row is the same as the bottom row. The Heavenly Number is also known as the least common multiple. The user then added stones to the row with the fewest number of stones at any given time. The user repeated this process until the Heavenly Number was found. Once the “Heavenly Number was found, the user counted the number of stones in each pit, up to the pin. The user manipulated the fractions by adding and subtracting.

### Example 2: Multiplying or Dividing Decimals by Powers of Ten

A user was given a decimal number, 1.025, and placed the stones in pits according to the place name value marker. The user moved the stones first to the left and then to the right to divide and multiply. The user then recorded the resulting number.

The above description is illustrative and is not restrictive. Many variations of the invention will become apparent to those skilled in the art upon review of the disclosure. Therefore, the scope of the invention should be determined not with reference to the above description but instead should be determined with reference to the pending claims along with their full scope or equivalents.

1. A manipulative comprising a board, wherein the board comprises a series of pits arranged in rows and at least one counter or well at an end of the board.

2. The manipulative of claim 1, wherein the pits are evenly divided and arranged in rows.

3. The manipulative of claim 1, wherein the board comprises at least eighteen pits.

4. The manipulative of claim 3, wherein each row comprises at least nine pits.

5. The manipulative of claim 1, wherein the board is between about 12 inches-about 36 inches long.

6. The manipulative of claim 1, wherein the board height is between about 0.5 inches-about 1.5 inches.

7. The manipulative of claim 1, wherein the board has a width of about 4 inches-about 10 inches.

8. The manipulative of claim 1, wherein the board further comprises a marking system.

9. The manipulative of claim 8, wherein the marking system is numerical and the numbers correspond to specific place name values.

10. The manipulative of claim 8, wherein the marking system comprises a pin system, wherein the board comprises at least one hole for receiving at least one pin.

11. The manipulative of claim 10, wherein placement of the at least one pin corresponds to a specific place name value.

12. The manipulative of claim 1, wherein the manipulative further comprises small stones.

13. The manipulative of claim 1, wherein the manipulative is used in a method for modeling addition, subtraction, multiplication, or division of fractions, mixed numbers, or decimal numbers.

14. A method of using a manipulative, the method comprising
providing a board, wherein the board comprises a series of pits arranged equally into a top row and a bottom row, at least one counter or well at an end of the board, and at least one hole for receiving at least one pin;
providing at least one pin;
placing at least one stone in a pit based on a given number;
generating an output based on the location of the stone;
correlating values based on the placement of the at least one pin in at least one hole with a location of at least one stone to generate resulting values.

15. The method of claim 14, wherein the method further comprises placing stones in the pits until the number of stones in the top row of the board is equal to the number of stones in the bottom row of the board.

16. The method of claim 14, wherein the given number is a numerator, a decimal number, a fraction, or a mixed number.

17. The method of claim 14, wherein the board further comprises a computing system, the computing system comprising an interface to receive the generated output; and a processor configured to execute instructions stored in a memory, wherein execution of the instructions causes the processer to correlate values and generate the resulting values.

18. The method of claim 17, wherein the board further comprises a display device.

19. The method of claim 18, wherein the execution of the instructions causes the processor to present the resulting values on the display device.

20. A non-transitory computer-readable storage medium comprising instructions that, in response to being executed, cause a computing system to:
generate an output based on the location of stones on a board of a manipulative; and
correlate values based on placement of at least one pin in at least one hole with a location of at least one stones to generate resulting values.
